(19) United States
(12) Patent Application Publication
(10) Pub. No.: US 2025/0149551 A1
(43) Pub. Date: May 8, 2025

(54) ANODE MATERIAL AND LITHIUM-ION BATTERY

(71) Applicant: BTR NEW MATERIAL GROUP CO., LTD., Shenzhen (CN)

(72) Inventors: MINGJIE LIU, Shenzhen (CN); PENG HE, Shenzhen (CN); CHENGMAO XIAO, Shenzhen (CN); EMING GUO, Shenzhen (CN); JIANGUO REN, Shenzhen (CN); XUEQIN HE, Shenzhen (CN)

(21) Appl. No.: 19/011,875

(22) Filed: Jan. 7, 2025

Related U.S. Application Data
(63) Continuation of application No. PCT/CN2024/096641, filed on May 31, 2024.

(30) Foreign Application Priority Data
Sep. 28, 2023 (CN) 202311280138.7

(51) Int. Cl. H01M 4/36; H01M 4/38; H01M 4/587; H01M 4/62; H01M 10/0525; H01M 10/42

(52) U.S. Cl. CPC H01M 4/364; H01M 4/366; H01M 4/386; H01M 4/587; H01M 4/62; H01M 10/0525; H01M 10/4235

(57) ABSTRACT

The present application relates to an anode material and a lithium-ion battery. The anode material includes an active material including a porous matrix and a silicon matrix. At least a portion of the silicon matrix is distributed in pores of the porous matrix. In the infrared spectrum obtained by testing the anode material using an infrared spectrometer, there are a stretching vibration peak of SiH₂ bond at a wave number of 2090 cm⁻¹ and a stretching vibration peak of SiH bond at a wave number of 2000 cm⁻¹. A ratio Z of an area of the stretching vibration peak of the SiH₂ bond to an area of the stretching vibration peak of the SiH bond is in a range from 0.01 to 5.0. Within the above defined range, it indicates that the silicon matrix in the anode material mainly exists in the form of SiH bonds.

### TECHNICAL FIELD

The present disclosure relates to a field of anode material technology, particularly relates to an anode material and a lithium-ion battery.

### BACKGROUND

Silicon-based anode material has advantages of high specific capacity, low voltage platform, environmental friendliness, and abundant resources, and are expected to replace graphite negative electrodes in the next generation of high-energy lithium-ion batteries. However, silicon undergoes a significant volume change during the extraction/insertion processes, which can easily lead to particle pulverization and detachment from the collector. In addition, repeated volume changes of silicon materials during electrochemical cycling also result in the continuous destruction and regeneration of SEI films formed on a surface of silicon materials, leading to a continuous consumption of lithium ions and ultimately resulting in rapid capacity decay.

The crystalline silicon in the silicon-based anode material is a main factor causing the volume expansion changes in the silicon-based anode material. In order to solve these problems, researchers usually modify the crystalline silicon by processes such as nano treatment (impart a nano size to the crystalline silicon), carbon coating, and polymer coating, and such processes can suppress a volume expansion of the crystalline silicon to some extent. However, the above methods have limited effects on suppressing the volume expansion of silicon and cannot meet the requirements of existing high-energy density lithium-ion batteries.

Therefore, there is an urgent need for an anode material that has a low expansion and excellent cycling performance.

### BRIEF DESCRIPTION OF THE DRAWINGS

Implementations of the present technology will now be described, by way of embodiments only, with reference to the attached figures.

FIG. 1 is a flow chart of an embodiment of making an anode material in the present disclosure.

FIG. 2 is an infrared spectrum of the anode material prepared in Example 2 of the present disclosure.

FIG. 3 is a Raman spectrum of the anode material prepared in Example 2 of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like.

The present disclosure provides an anode material including an active material. The active material includes a porous matrix and a silicon matrix. At least a portion of the silicon matrix is distributed in pores of the porous matrix. In an infrared spectrum obtained by testing the anode material using an infrared spectrometer, a stretching vibration peak at a wave number of 2090 cm⁻¹ corresponding to SiH₂ bond and a stretching vibration peak at a wave number of 2000 cm⁻¹ corresponding to SiH bond are observed. A ratio Z of an area of the vibration peak of the SiH₂ bond to an area of the vibration peak of the SiH bond is in a range of from 0.01 to 5.0.

In the above scheme, the active material of the anode material of the present disclosure includes the porous matrix and the silicon matrix, and the silicon matrix is distributed in the pores of the porous matrix. The porous matrix is conducive to alleviate a volume expansion of the silicon matrix, act as an elastic conductor for the anode material, provide ion and electron transport paths for the anode material during charging and discharging process, enhance a conductivity of the anode material, and improve a rate performance of the anode material. The silicon matrix embedding into the pores of the porous matrix is conducive to reduce agglomeration of the silicon matrix particles, which can lead to stress concentration and damage to the entire anode material structure. Secondly, the silicon matrix has a high lithium insertion voltage (0.4V), which can suppress formation of lithium dendrites (lithium dendrite formation potential 0V), thereby improving safety performance of anode materials used in batteries. In addition, a value of Z of the area of the vibration peak of SiH₂ bond to that of SiH bond in the anode material of the present disclosure is from 0.01 to 5.0. A stability of SiH bond is greater than that of SiH₂ bond, and the silicon matrix having more SiH bonds is beneficial for improving a structural stability of the anode material, reducing occurrence of side reactions between the anode material and the electrolyte, and thereby enhancing the cycling performance and expansion performance of the anode material. The pyrolysis process of silane produces SiH bonds, SiH₂ bonds, and SiH₃ bonds, and SiH₃ bonds only exist in large quantities when pyrolysis of the silane is insufficient.

Compared to the anode materials containing crystalline silicon, the crystalline silicon is transformed into amorphous Li—Si during lithium insertion, resulting in a two-phase reaction. In this disclosure, due to a disordered structure of the silicon matrix, a homogeneous reaction occurs during lithium insertion. Therefore, a volume expansion of the silicon matrix in this disclosure is less than that of the crystalline silicon, and the volume expansion of the silicon matrix in this disclosure is less, which can improve the expansion performance of the anode material.

In this disclosure, a value of Z can be 0.01, 0.05, 0.1, 0.3, 0.8, 1.0, 2.0, 3.0, 4.0, or 5.0, etc., it can also be other values within the above range, and this disclosure does not limit it. Within the above limited range, the less the value of Z, the more SiH bonds there are in the silicon matrix, the more stable the silicon matrix is, and the more conducive it is to improve the cycling and expansion performance of the anode material. If the value of Z is greater than 5, it indicates that there are too many SiH₂ bonds in the silicon matrix of the anode material, and the SiH₃ bonds may also appear, leading to structural instability of the anode material and a decrease in its cycling and expansion properties. In one embodiment, the value of Z is in a range from 0.05 to 3.0. In other embodiments, the value of Z is in a range from 0.05 to 0.5.

In some embodiments, the silicon matrix includes silicon particles.

In some embodiments, a porosity of the anode material is in a range from 0.01% to 10%. For example, it can be 0.01%, 1%, 3%, 5%, 8%, or 10%, etc. Of course, it can also be other values within the above range, and this disclosure does not limit it. Within the aforementioned limits, it is possible to increase the energy density of anode materials while suppressing volume expansion.

In some embodiments, HF acid solution having a volume of 150 mL and a mass percentage of 20% is added drop by drop into anode material having a mass of 10 g under stirring, SiF₄ and H₂ gases are generated and heat is released. After no gas is generated, supernatant acid is removed by centrifugation. Then, HF acid solution having a volume of 150 mL and a mass percentage of 20% is added to the anode material again, stirred for 12 hours, and centrifuged again to remove the supernatant acid. Finally, the anode material is washed by pure water until neutral and dried to obtain the anode material having removed the silicon substrate, i.e., the porous substrate.

In some embodiments, the porosity of the anode material after removing the silicon matrix is in a range from 30% to 70%. For example, 30%, 40%, 50%, 55%, 60%, or 70%. Of course, it can also be other values within the above range, and this disclosure does not limit it. Within the aforementioned limited range, the anode material after removing the silicon matrix has sufficient space to disperse the silicon matrix and has sufficient anti crushing strength, which can improve the energy density of the anode material while suppressing its volume expansion.

In some embodiments, an average pore size of the anode material after removing the silicon matrix is in a range from 0.2 nm to 10 nm, which can be 0.2 nm, 0.5 nm, 2 nm, 5 nm, 8 nm, or 10 nm, etc. Of course, it can also be other values within the above range, and this disclosure does not limit it.

In some embodiments, an average particle size of the silicon matrix is in a range from 1 nm to 10 nm, such as 1 nm, 2 nm, 3 nm, 4 nm, 5 nm, 6 nm, 7 nm, 8 nm, 9 nm, or 10 nm. Of course, other values within the above range are also possible, and this disclosure does not limit it. Within the above particle size range, it is advantageous for the silicon matrix to be embedded into the pores of the porous matrix. In one embodiment, the silicon matrix has an average particle size of 1 nm to 5 nm.

In some embodiments, a weight percentage of the silicon matrix (i.e. silicon element) in the anode material is in a range from 5% to 90%, such as 5%, 10%, 20%, 50%, 70%, 80%, or 90%, etc. Of course, other values within the above range are also possible, and this disclosure does not limit it. Within the above limitations, it indicates that anode material in this disclosure with a higher load of the silicon matrix is beneficial for improving the capacity performance of the anode material.

In some embodiments, at least a portion of the silicon matrix is distributed on a surface of the porous matrix. It can be understood that in order to improve a rate performance of the anode material, the silicon matrix of the present disclosure is mainly distributed inside the porous matrix.

In some embodiments, the anode material further includes a coating layer on at least a portion of the surfaces of the active material. On the one hand, the coating layer can reduce occurrence of side reactions caused by the electrolyte entering in the anode material, resulting in a decrease in initial efficiency and capacity. On the other hand, the coating layer can alleviate the volume expansion of silicon to a certain extent, reduce the volume expansion of the entire anode material, and reduce a swelling of the electrode sheet made of the anode material.

In some embodiments, the coating layer includes at least one of carbon material, metal oxide, and metal sulfide.

In some embodiments, the coating layer may be at least one of a carbon layer, a metal oxide layer, and a metal sulfide layer. In some embodiments, the carbon material includes at least one from graphene, soft carbon, hard carbon, and conductive polymers. Specifically, the conductive polymer includes at least one of polyaniline, polyacetylene, polypyrrole, polythiophene, poly-3-hexylthiophene, poly (p-phenylene ene), poly (pyridine), and poly (phenylene glycol).

In some embodiments, the metal oxide includes at least one of titanium oxide, aluminum oxide, lithium oxide, cobalt oxide, and vanadium oxide.

In some embodiments, the metal sulfide includes at least one of tin sulfide, molybdenum sulfide, titanium sulfide, iron sulfide, and copper sulfide.

In some embodiments, a thickness of the coating layer is in a range from 5 nm to 500 nm. For example, it can be 5 nm, 10 nm, 30 nm, 80 nm, 120 nm, 200 nm, 300 nm, 400 nm, or 500 nm, etc. Of course, it can also be other values within the above range, which are not limited. In some embodiments, the thickness of the coating layer is between 10 nm and 100 nm. The coating layer can reduce contact between the silicon and electrolyte, reduce formation of passivation film, and improve reversible capacitance of the battery. If the thickness of the coating layer is greater than 500 nm, the lithium-ion transport efficiency will be reduced, which is not conducive to high rate charging and discharging of the anode material and reduces a comprehensive performance of the anode material. The thickness of the coating layer is less than 5 nm, which is not conducive to increasing the conductivity of the anode material and has a weak suppression performance on the volume expansion of the anode material, resulting in poor cycling performance.

In some embodiments, a median particle size D50 of the anode material is in a range from 5 μm to 10 μm. For example, it can be 5 μm, 6 μm, 7 μm, 8 μm, 9 μm, or 10 μm, etc. Of course, it can also be other values within the above range, and this disclosure does not limit it. In one embodiment, the anode material has a median particle size D50 of a range from 5 μm to 8 μm. In other embodiment, the anode material has a median particle size D50 of a range from 7 μm to 8 μm.

In some embodiments, a minimum particle size D00 of the anode material is in a range from 1 μm to 3 μm. For example, it can be 1 μm, 1.5 μm, 2 μm, 2.5 μm, or 3 μm, etc. Of course, it can also be other values within the above range, and this disclosure does not limit it here. In one embodiment, the minimum particle size D00 for the anode material is in a range from 1 μm to 2 μm.

In some embodiments, a D90 of the anode material is in a range from 14 μm to 25 μm. For example, it can be 14 μm, 17 μm, 20 μm, 23 μm, or 25 μm, etc. Of course, it can also be other values within the above range, and this disclosure does not limit it. In one embodiment, the anode material has a D90 of 18 μm to 20 μm.

Using a laser particle size analyzer to test anode materials, a symmetrical distribution similar to a normal distribution is exhibited. In the above symmetrical distribution, D90 is a particle size with a cumulative number distribution of 90% of the material particles, D00 is a minimum size of the material particles that can be measured in the above distribution, and D50 is a particle size with a cumulative number distribution of 50% of the material particles, also known as the median particle size. An ideal battery material needs to have a narrow particle size distribution. Studies have shown that too small material particles can make it difficult for silicon to deposit, and the battery material continuously consumes electrolyte during cycling, resulting in a deterioration of capacity retention. However, excessively large material particles will deposit too much silicon matrix, which makes the anode material have a greater expansion rate, making it easy to cause particle pulverization during cycling, which can lead to continuous thickening of SEI. Therefore, by controlling the particle size distribution, the cycling performance of the anode materials can be improved. In the anode material of this disclosure, the particle size distribution of the material is relatively concentrated, which not only reduces the above-mentioned problems, but also further has a high packing density, which facilitates improvement of the electrochemical and cycling performance of the anode material.

In some embodiments, the porous matrix includes porous carbon.

In some embodiments, the anode material is shown in the Raman spectrum obtained by Raman spectroscopy using a measurement light source having a wavelength of 633 nm. The anode material has a characteristic peak I_{D} at 1310 cm⁻¹ to 1350 cm⁻¹ and a characteristic peak I_{G} at 1580 cm⁻¹ to 1620 cm⁻¹. A ratio I_{D}/I_{G} of an area of the peak I_{D} to an area of the peak I_{G} is in a range from 1.6 to 2.5, which can be, for example, 1.6, 1.8, 2.0, 2.2, 2.3, or 2.5. Of course, other values within the above range can also be used, and this disclosure does not limit it. In the Raman spectrum of the present disclosure, the D peak corresponds to the pores and defects of the porous carbon, and the G peak corresponds to the E2 g stacking method of graphite layers of the porous carbon. The present disclosure uses I_{D}/I_{G} to represent a difficulty of the silicon depositing on the porous carbon. Within the above defined range, it indicates that porous carbon has more pores and defects, and its surface and interior have more silicon nucleation sites, which is conducive to silicon deposition, and can greatly increase the silicon loading in the anode material, thereby improving the effective utilization rate of the silicon source, and thereby increasing the tap density and specific capacity of the entire anode material, and improving the energy density of the entire battery material made of the anode material. In one embodiment, I_{D}/I_{G} is in a range from 1.6 to 2.3. In other embodiments, I_{D}/I_{G} is in a range from 1.8 to 2.2.

In some embodiments, a specific surface area of the anode material ranges from 1.0 m²/g to 10.0 m²/g. For example, it can be 1.0 m²/g, 2.0 m²/g, 3.0 m²/g, 4.0 m²/g, 5.0 m²/g, 6.0 m²/g, 7.0 m²/g, 8.0 m²/g, 9.0 m²/g, or 10.0 m²/g, etc. Of course, other values within the above range are also possible, and this disclosure does not limit it. It can be understood that controlling the specific surface area of the anode material within the above range can reduce formation of the SEI film on the anode material and improve electrochemical performance of the anode material.

In some embodiments, a powder conductivity of the anode material is in a range from 0.1 S/cm to 10.0 S/cm. For example, it can be 0.1 S/cm, 1.0 S/cm, 3.0 S/cm, 5.0 S/cm, 7.0 S/cm, 9.0 S/cm, or 10.0 S/cm, etc. Of course, it can also be other values within the above range, and this disclosure does not limit it. It can be understood that controlling the powder conductivity of the anode material within the above range can improve the rate performance of the anode material.

In some embodiments, the powder conductivity of the anode material ranges from 0.1 S/cm to 10.0 S/cm. For example, it can be 0.1 S/cm, 1.0 S/cm, 3.0 S/cm, 5.0 S/cm, 7.0 S/cm, 9.0 S/cm, or 10.0 S/cm, etc. Of course, it can also be other values within the above range, and this disclosure does not limit it. It can be understood that controlling the powder conductivity of the anode material within the above range can improve the rate performance of the anode material.

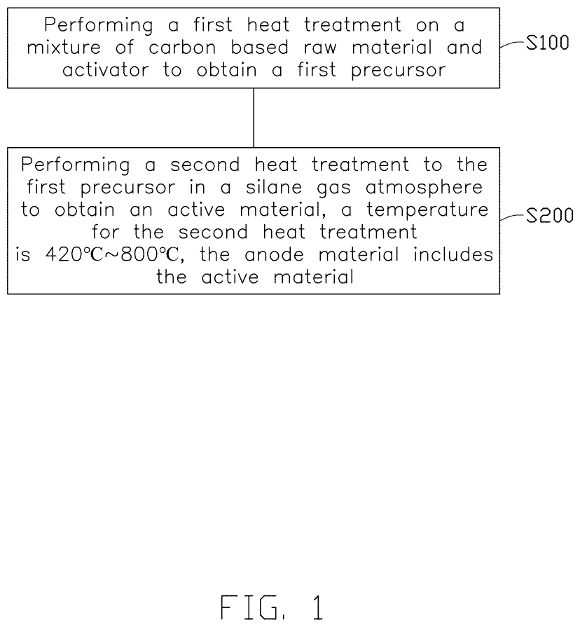

The present disclosure also provides a method for making an anode material, as shown in FIG. 1, including the following steps.

S100: mixing carbon-based raw material and activator in a certain proportion in a VC mixer having a processing capacity of 10 L to 50 L, with a stirring frequency of 5 to 30 HZ, and a stirring time of 30 to 90 min. After mixing evenly, the mixture is transferred to a rotary furnace for a first heat treatment. During the heat treatment, the oxygen content in the rotary furnace is less than 100 ppm, and a pressure of the rotary furnace is 10 to 100 pa. The heat-treated sample is mechanically grinded to obtain a first precursor having a particle size D50 of 5 to 15 μm.

S200: performing a second heat treatment to the first precursor in an inert gas atmosphere. A deviation between a temperature of the reaction system and a set temperature value is less than 10° C. After the reactor reaches a reaction temperature, it needs to be maintained at a constant reaction temperature for 10 to 60 minutes. A total reaction gas rate is 15-50 L/min, a concentration of the silane is 10% to 60%, and a pressure of the reaction system is 0 to 30 Kpa. The active material is obtained after the reaction is complete, and the anode material includes the active material. A temperature for the second heat treatment is 420° C. to 800° C.

In the above technical solution, the present disclosure performs the first heat treatment on a mixture of the carbon-based raw material and the activator to form pores on surface and inside of the carbon-based raw material, obtaining porous carbon, which is the first precursor. Further, the porous carbon with introducing silane gas performs the second heat treatment. By controlling the temperature of the second heat treatment to 420° C. to 800° C., the silane can be fully decomposed to generate a large amount of silicon matrix in the form of SiH bonds. The silicon matrix is deposited inside and/or on the surface of the first precursor, thereby obtaining a core in which at least part of the silicon matrix is distributed in the pores of the porous carbon. A large amount of silicon matrix in the form of SiH bonds is conducive to improving a structural stability of the anode material, enhancing mechanical properties of the anode material, reducing the occurrence of side reactions between the anode materials and electrolytes, alleviating the volume expansion of the anode materials during lithium insertion stage and improving cycling stability of the anode material. Porous carbon is coated on at least part of the surface of the silicon matrix. On the one hand, porous carbon can act as an elastic conductor, providing transport paths for ions and electrons during the charging and discharging process of the anode material, increasing conductivity between the silicon matrix and the outside world, thereby improving the rate performance of the anode material. On the other hand, embedding the silicon matrix into the porous carbon can improve conductivity of the silicon matrix, thereby enhancing the rate performance of the material and meeting the requirements for achieving fast charging characteristics in batteries.

It can be understood that silane is fully decomposed to generate a larger amount of silicon matrix in the form of SiH bonds. That is, there are many SiH bonds in the chemical bonds in the silicon matrix. In the silicon matrix generated by incomplete decomposition of the silane, the silicon matrix exists in the form of SiH, SiH₂ bonds, and SiH₃ bonds. The silicon matrix prepared by the preparation method of this disclosure can fully decompose the silane into amorphous silicon without generating polycrystalline silicon. At the same time, more SiH bonds exist in the silicon matrix, so that a value of Z of the area of the vibration peak of SiH₂ bond to the area of the vibration peak of SiH bond in the anode material satisfies Z=0.01 to 5.0, thereby improving the cycling performance and expansion performance of the anode material.

The following provides a specific introduction to the preparation method of the present disclosure in conjunction with the embodiments. The preparation method of the anode material of the present disclosure includes the following steps.

S100: mixing carbon-based raw material and activator in a certain proportion in a VC mixer having a processing capacity of 10 L to 50 L, with a stirring frequency of 5 to 30 HZ, and a stirring time of 30-90 min. After mixing evenly, the mixture is transferred to the rotary furnace for the first heat treatment. During the heat treatment, the oxygen content in the rotary furnace is less than 100 ppm, and the pressure of the rotary furnace is 10 to 100 pa. The heat-treated sample is mechanically grinded to obtain a first precursor having a particle size D50 of 5 to 15 μm.

In some embodiments, the carbon-based raw material includes at least one of fruit shell carbon, straw carbon, resin carbon, asphalt carbon, and carbohydrates.

In some embodiments, the activator includes at least one of water vapor, alkaline substance, and template agent. The above-mentioned activator contacts with the carbon-based materials at a certain temperature for activation. The activators can corrode the surface of the carbon-based material at high temperatures, causing originally closed pores in the carbon-based material to reopen and further expand. Some structures generate new pores due to selective oxidation.

In some embodiments, the alkaline substance includes at least one of potassium hydroxide and sodium hydroxide.

In some embodiments, the template agent includes at least one of calcium hydroxide, calcium oxide, magnesium oxide, magnesium hydroxide, melamine, aluminum oxide, and polymer template agent. Examples of the polymer template agent includes polyurethane, melamine resin, cellulose, polystyrene, polymethyl methacrylate, etc.

In some embodiments, the temperature for the first heat treatment is between 600° C. and 2000° C., such as 600° C., 800° C., 1000° C., 1100° C., 1500° C., 1800° C., or 2000° C. Of course, other values within the above range are also possible and are not limited. It can be understood that controlling the temperature of the first heat treatment within the above range is beneficial for activating the carbon-based raw material into pores and increasing the porosity of the porous carbon. In some embodiments, the temperature for the first heat treatment is in a range from 800° C. to 1500° C. In other embodiments, the temperature for the first heat treatment is in a range from 800° C. to 1100° C.

In some embodiments, the heating rate of the first heat treatment is between 5° C./min and 20° C./min. For example, it can be 5° C./min, 10° C./min, 15° C./min, 18° C./min, or 20° C./min, etc. Of course, it can also be other values within the above range, which are not limited.

In some embodiments, a time for the first heat treatment is between 2 hours and 10 hours, such as 2 hours, 3 hours, 5 hours, 8 hours, or 10 hours. Of course, other values within the above range are also possible and are not limited here.

In some embodiments, the first heat treatment further includes steps of washing and drying the material obtained from the first heat treatment.

In some embodiments, washing includes: acid washing the material obtained from the first heat treatment with and then washing it with water. Wherein the acid used in acid washing is at least one of hydrochloric acid, sulfuric acid, nitric acid, hydrofluoric acid, phosphoric acid, perchloric acid, acetic acid, and benzoic acid. A concentration of the acid ranges from 1 mol/L to 5 mol/L. For example, it can be 1 mol/L, 2 mol/L, 3 mol/L, 4 mol/L, or 5 mol/L. Of course, it can also be other values within the above range, which are not limited. It can be understood that a purpose of acid washing is to remove excess activators from the material. The first precursor is washed with deionized water after acid washing to wash the product to neutral.

In some embodiments, the drying temperature ranges from 80° C. to 150° C., and a specific temperature can be 80° C., 90° C., 100° C., 110° C., 120° C., 130° C., 140° C., and 150° C., among others. Of course, other values within the above range are also possible and are not limited here.

In some embodiments, the drying time ranges from 24 hours to 72 hours, and the specific time can be 24 hours, 30 hours, 36 hours, 42 hours, 48 hours, 52 hours, 60 hours, 72 hours, etc. Of course, it can also be other values within the above range and is not limited.

In some embodiments, the drying equipment is any one of an oven, a box furnace, and a double cone dryer.

In some embodiments, the first heat treatment further includes steps of pulverization and sieving the material obtained from the first heat treatment.

In some embodiments, the crushing uses at least one of ball milling pulverization, air flow pulverization, and mechanical pulverization, and mechanical pulverization is preferred.

In some embodiments, a median particle size of the first precursor after pulverization and sieving is between 5 μm and 10 μm, which can be, for example, 5 μm, 6 μm, 7 μm, 8 μm, 9 m, or 10 μm, and can also be other values within the above range, without limitation.

S200: performing the second heat treatment to the first precursor in silane gas atmosphere to obtain the anode material. The temperature of the second heat treatment is in a range from 420° C. to 800° C.

In some embodiments, the inflow rate of the silane is from 1 L/min to 10 L/min, such as 1 L/min, 3 L/min, 5 L/min, 7 L/min, 9 L/min, or 10 L/min. Of course, other values within the above range are also possible and are not limited. Within the above limited range, it is beneficial for the silane to fully pyrolyze and generate a larger amount of silicon matrix in the form of SiH bonds.

In some embodiments, the temperature of the second heat treatment is in a range from 420° C. to 800° C. For example, it can be 420° C., 500° C., 550° C., 600° C., 650° C., 700° C., 750° C., or 800° C., etc. Of course, it can also be other values within the above range, which are not limited. In some embodiments, the temperature for the second heat treatment is in a range from 550° C. to 650° C. Within the above limited range, it is beneficial for sufficient pyrolysis of silane gas to generate a larger amount of silicon matrix in the form of SiH bonds, which is beneficial for improving the structural stability of the anode material, and thereby enhancing cycling and expansion properties of the anode material. If the temperature is higher than 800° C., it is easy for the amorphous silicon generated by pyrolysis of the silane gas to transform into crystalline silicon, resulting in poor expansion performance of the anode material. If the second heat treatment temperature is lower than 420° C., pyrolysis of the silane gas is not sufficient, a conversion rate of the silane pyrolysis is low, and the silicon matrix for the silane pyrolysis mainly exists in coexistence of SiH bonds, SiH₂ bonds, and SiH₃ bonds, which reduces the structural stability of the anode material.

In some embodiments, a heating rate of the second heat treatment is in a range from 3° C./min to 20° C./min, which can be 3° C./min, 5° C./min, 8° C./min, 10° C./min, 13° C./min, 16° C./min, 18° C./min, or 20° C./min, etc. Of course, other values within the above range are also possible and are not limited.

In some embodiments, the second heat treatment is carried out in a protective gas atmosphere, which includes at least one of nitrogen, argon, and helium.

In some embodiments, a time for the second heat treatment is between 100 min and 600 min, such as 100 min, 200 min, 300 min, 400 min, 500 min, or 600 min, etc. Of course, other values within the above range are also possible and are not limited.

In some embodiments, an equipment for the second heat treatment includes at least one of a kiln, a chemical vapor deposition equipment, and a chemical vapor infiltration equipment.

In some embodiments, it further includes mixing the coating material with the material obtained after the second heat treatment and performing a third heat treatment after the second heat treatment.

In this step, the coating material is mixed with the material obtained from the second heat treatment and subjected to the third heat treatment to form a coating layer. On one hand, it can reduce occurrence of side reactions caused by electrolyte entering the anode material, resulting in a decrease in initial efficiency and capacity. On the other hand, it can work together with the core material to alleviate a volume expansion of the silicon matrix, reduce a volume expansion of the entire anode material, and reduce swelling of the electrode sheet made of the anode material.

In some embodiments, the coating material includes at least one of carbon source, metal oxide, and metal sulfide.

In some embodiments, the carbon source includes at least one of a gaseous carbon source and a solid carbon source.

In some embodiments, the gaseous carbon source includes at least one of acetylene, methane, propylene, benzene, ethanol, methanol, ethylene, propane, and butane.

In some embodiments, an inlet flow rate of the gaseous carbon source is in a range from 1 L/min to 15 L/min. For example, it can be 1 L/min, 3 L/min, 5 L/min, 8 L/min, 10 L/min, 12 L/min, or 15 L/min, etc. Of course, it can also be other values within the above range, which are not limited.

In some embodiments, the solid carbon source includes at least one of sucrose, fructose, glucose, asphalt, phenolic resin, polyimide, citric acid, epoxy resin, amino resin, polystyrene, polyacrylic acid, carboxymethyl cellulose, and acetate butyrate fiber.

In some embodiments, a weight ratio of the solid carbon source to the material obtained from the second heat treatment is (0.2-2): 1. For example, it can be 0.2:1, 0.5:1, 0.8:1, 1.5:1, 1.8:1, or 2:1, etc. Of course, it can also be other values within the above range, which are not limited.

In some embodiments, the metal oxide includes at least one of iron oxide, zinc oxide, tin oxide, copper oxide, and titanium oxide.

In some embodiments, the metal sulfide includes at least one of tin sulfide, molybdenum sulfide, titanium sulfide, iron sulfide, and copper sulfide.

In some embodiments, a weight ratio of the metal oxide to the material obtained from the second heat treatment is (0.2-2): 1. For example, it can be 0.2:1, 0.5:1, 0.8:1, 1.5:1, 1.8:1, or 2:1, etc. Of course, it can also be other values within the above range, which are not limited.

In some embodiments, a weight ratio of metal sulfide to the material obtained from the second heat treatment is (0.2-2): 1. For example, it can be 0.2:1, 0.5:1, 0.8:1, 1.5:1, 1.8:1, or 2:1, etc. Of course, it can also be other values within the above range, which are not limited.

In some embodiments, the temperature of the third heat treatment is in a range from 300° C. to 1100° C. For example, it can be 300° C., 400° C., 500° C., 600° C., 700° C., 800° C., 900° C., 1000° C., 1100° C., etc. Of course, it can also be other values within the above range, which are not limited. Within the above limited range, it is possible to ensure complete carbonization of the coating material without significantly affecting the silicon matrix of the core. In order to reduce changes in the silicon matrix during the third heat treatment process, in some embodiments, the temperature for the third heat treatment is in a range from 400° C. to 800° C. Furthermore, in other embodiments, the temperature for the third heat treatment is in a range from 500° C. to 700° C.

In some embodiments, the time for the third heat treatment is between 2 hours and 5 hours, such as 2 hours, 2.5 hours, 3 hours, 3.5 hours, 4 hours, 4.5 hours, or 5 hours. Of course, other values within the above range are also possible and are not limited.

Thirdly, the present disclosure provides a lithium-ion battery including the anode material prepared by the above-mentioned preparation method.

The embodiments of the present disclosure are not limited to these examples as long as they do not exceed the main idea.

### Embodiment 1

(1) 400 g of coal tar pitch, 120 g of calcium hydroxide, and 50 g of potassium hydroxide were mixed using a VC mixer with a stirring frequency of 20 Hz for 30 minutes to prepare a precursor having a uniform pore size distribution. After mixing evenly, the precursor was placed in a rotary furnace with an oxygen content of less than 100 ppm and a pressure of 10-100 pa. The mixture was heated to 700° C. at a rate of 10° C./min and kept at a constant temperature of 700° C. for 5 hours. The resulting material was soaked in 2 mol/L hydrochloric acid for 1 hour, filtered and washed with pure water until neutral, put in a 100° C. oven for 4 hours, and then grinded and sieved through a 325 mesh sieve.

(2) 200 g of the material obtained in step (1) was placed into a CVD reactor and the temperature was raised to 550° C. at a rate of 5° C./min, kept the temperature of 550° C. for 60 minutes to ensure temperature stability of the CVD reactor, and 0.6 L/min of SiH₄ and 0.6 L/min of nitrogen gas were introduced into the CVD reactor, a pressure of the reaction system was 0 to 30 Kpa, and the reaction system reacted for 300 minutes to obtain the first precursor.

(3) the first precursor was placed in a CVD reactor, the temperature was raised to 700° C. at a rate of 10° C./min, 1 L/min of C₃H₆ and 2 L/min of nitrogen gas were introduced into the CVD reactor, and reacted for 150 minutes.

(4) the material obtained in step (3) was placed in a VC mixer, grinded and sieved through a 325 mesh sieve to obtain the anode material.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 2

(1) 400 g of coal tar pitch, 120 g of calcium hydroxide, and 50 g of potassium hydroxide were mixed using a VC mixer with a stirring frequency of 20 Hz for 30 minutes to prepare a precursor having a uniform pore size distribution. After mixing evenly, the precursor was placed in a rotary furnace with an oxygen content of less than 100 ppm and a pressure of 10-100 pa. The mixture was heated to 900° C. at a rate of 10° C./min and kept at a constant temperature of 900° C. for 5 hours. The resulting material was soaked in 2 mol/L hydrochloric acid for 1 hour, filtered and washed with pure water until neutral, put in a 100° C. oven for 4 hours, and then grinded and sieved through a 325 mesh sieve.

(2) 200 g of the material obtained in step (1) was placed into a CVD reactor and the temperature was raised to 550° C. at a rate of 5° C./min, kept the temperature of 550° C. for 60 minutes to ensure temperature stability of the CVD reactor, and 0.6 L/min of SiH₄ and 0.6 L/min of nitrogen gas were introduced into the CVD reactor, a pressure of the reaction system was 0-30 Kpa, and the reaction system reacted for 300 minutes to obtain the first precursor.

(3) the first precursor was placed in a CVD reactor, the temperature was raised to 700° C. at a rate of 10° C./min, 1 L/min of C₃H₆ and 2 L/min of nitrogen gas were introduced into the CVD reactor, and reacted for 150 minutes.

(4) the material obtained in step (3) was placed in a VC mixer, grinded and sieved through a 325 mesh sieve to obtain the anode material.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

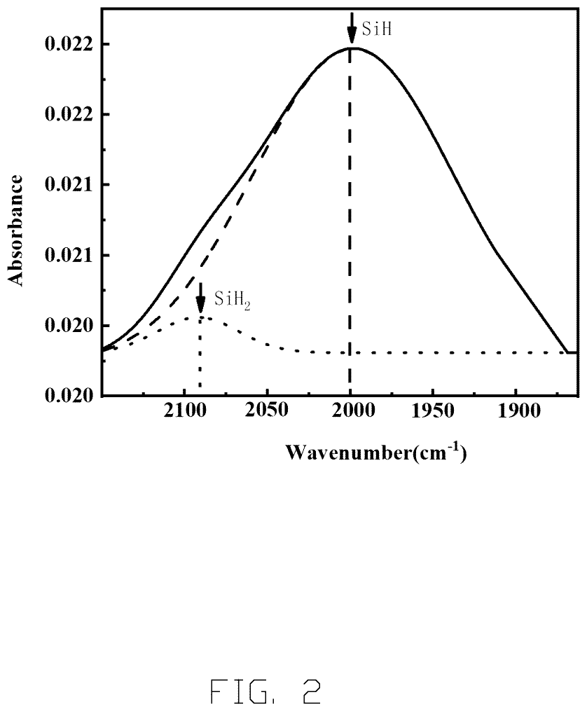

The infrared spectrum of the anode material prepared in this embodiment is shown in FIG. 2. It can be seen from FIG. 2 that the anode material prepared in the embodiment 2 has a stretching vibration peak of SiH₂ bond at a wave number of 2090 cm⁻¹ and a stretching vibration peak of SiH bond at a wave number of 2000 cm⁻¹. The above infrared spectrum data was imported into Origin software, and the stretching vibration peak of SiH bond at a wave number of 2000 cm⁻¹ and the stretching vibration peak of SiH₂ bond at a wave number of 2090 cm⁻¹ were used as a double peak fitting positions, a Gauss fitting optimization method was used to fit the two peaks, and the fitting variance R² was in the range of 0.6-0.95. A value of Z value of peak area represents a ratio of SiH bond and SiH₂ bond, and also represents a degree of silane pyrolysis reaction. In addition, no vibration peak of SiH₃ bond was found at 907 cm⁻¹ in FIG. 2, indicating absence of SiH₃ bond in the silicon based carbon material, further indicating that pyrolysis of the silane is relatively sufficient.

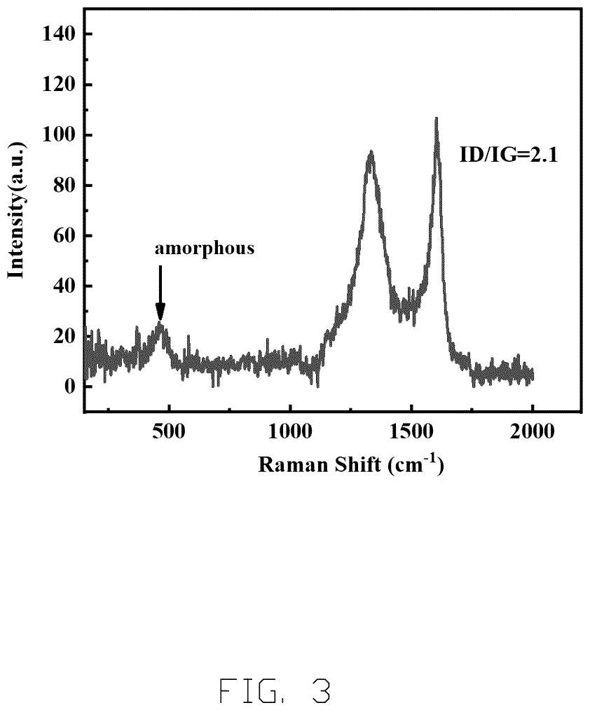

The Raman spectrum of the anode material prepared in this embodiment is shown in FIG. 3. It can be seen from FIG. 3 that the anode material of embodiment 2 has a characteristic peak at 480 cm⁻¹, identified as a characteristic peak of amorphous silicon, indicating that the silane pyrolyzes fully and generates amorphous silicon in this embodiment.

### Embodiment 3

(1) 400 g of coal tar pitch, 120 g of calcium hydroxide, and 50 g of potassium hydroxide were mixed using a VC mixer with a stirring frequency of 20 Hz for 30 minutes to prepare a precursor having a uniform pore size distribution. After mixing evenly, the precursor was placed in a rotary furnace with an oxygen content of less than 100 ppm and a pressure of 10-100 pa. The mixture was heated to 1100° C. at a rate of 10° C./min and kept at a constant temperature of 1100° C. for 5 hours. The resulting material was soaked in 2 mol/L hydrochloric acid for 1 hour, filtered and washed with pure water until neutral, put in a 100° C. oven for 4 hours, and then grinded and sieved through a 325 mesh sieve.

(2) 200 g of the material obtained in step (1) was placed into a CVD reactor and the temperature was raised to 550° C. at a rate of 5° C./min, kept the temperature of 550° C. for 60 minutes to ensure temperature stability of the CVD reactor, and 0.6 L/min of SiH₄ and 0.6 L/min of nitrogen gas were introduced into the CVD reactor, a pressure of the reaction system was 0-30 Kpa, and the reaction system reacted for 300 minutes to obtain the first precursor.

(3) the first precursor was placed in a CVD reactor, the temperature was raised to 700° C. at a rate of 10° C./min, 1 L/min of C₃H₆ and 2 L/min of nitrogen gas were introduced into the CVD reactor, and reacted for 150 minutes.

(4) the material obtained in step (3) was placed in a VC mixer, grinded and sieved through a 325 mesh sieve to obtain the anode material.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 4

Differences between the Embodiment 4 and the Embodiment 2 are that in step (2): the temperature was raised to 420° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 5

Differences between the Embodiment 5 and the Embodiment 2 are that in step (2): the temperature was raised to 450° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 6

Differences between the Embodiment 6 and the Embodiment 2 are that in step (2): the temperature was raised to 480° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 7

Differences between the Embodiment 7 and the Embodiment 2 are that in step (2): the temperature was raised to 510° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 8

Differences between the Embodiment 8 and the Embodiment 2 are that in step (2): the temperature was raised to 600° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 9

Differences between the Embodiment 9 and the Embodiment 2 are that in step (2): the temperature was raised to 650° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 10

Differences between the Embodiment 10 and the Embodiment 2 are that in step (2): the temperature was raised to 800° C. at a rate of 5° C./min, 0.6 L/min of SiH₄ and 0.6 L/min of nitrogen gas were introduced and reacted for 300 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 11

Differences between the Embodiment 11 and the Embodiment 4 are that in step (2): the temperature was raised to 420° C. at a rate of 5° C./min, 0.6 L/min of SiH₄ and 0.6 L/min of nitrogen gas were introduced and reacted for 350 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 12

Differences between the Embodiment 12 and the Embodiment 8 are that in step (2): the temperature was raised to 650° C. at a rate of 5° C./min, 0.6 L/min of SiH₄ and 0.6 L/min of nitrogen gas were introduced and reacted for 270 minutes.

The anode material obtained in this embodiment includes a core and a coating layer covering a surface of the core. The core includes porous carbon and silicon matrix inside and/or on the surface of the porous carbon. The silicon matrix mostly exists in the form of SiH bonds, and the coating layer is a carbon layer.

### Embodiment 13

(1) 500 g coconut shell charcoal was placed in a reactor and heated to 900° C. at a rate of 10° C./min. 30 g/min of water vapor was introduced for activation for 120 minutes. The resulting material was then soaked in 2 mol/L hydrochloric acid for 1 hour, filtered, and washed with pure water until neutral. After 4 hours in a 100° C. oven, it was grinded and sieved through a 325 mesh sieve.

(2) 200 g of the material obtained in step (1) was placed into a CVD reactor and the temperature was raised to 550° C. at a rate of 5° C./min, the temperature of 550° C. was kept for 60 minutes to ensure temperature stability of the CVD reactor; 0.6 L/min of SiH₄ and 0.6 L/min of nitrogen gas were introduced into the reactor, a pressure of the reaction system was 0-30 Kpa and reacted for 300 minutes to obtain the first precursor.

(3) the first precursor was placed in a CVD reactor, the temperature was raised to 700° C. at a rate of 10° C./min, 1 L/min of C₃H₆ and 2 L/min of nitrogen gas were introduced into the CVD reactor and reacted for 150 minutes.

(4) the material obtained in step (3) was placed in a VC mixer, grinded and sieved through a 325 mesh sieve to obtain the anode material.

The anode material obtained in this embodiment includes a core and a coating layer covering the surface of the core. The core includes porous carbon and a silicon matrix located inside and/or on the surface of the porous carbon. The silicon matrix is mostly present in the form of SiH bonds, and the coating layer is a carbon layer.

### Comparative Example 1

(1) 400 g of coal tar pitch, 120 g of calcium hydroxide, and 50 g of potassium hydroxide were mixed using a VC mixer with a stirring frequency of 20 Hz for 30 minutes to prepare a precursor having a uniform pore size distribution. After mixing evenly, the precursor was placed in a rotary furnace with an oxygen content of less than 100 ppm and a pressure of 10-100 pa. The mixture was heated to 700° C. at a rate of 10° C./min and kept at a constant temperature of 700° C. for 5 hours. The resulting material was soaked in 2 mol/L hydrochloric acid for 1 hour, filtered and washed with pure water until neutral, put in a 100° C. oven for 4 hours, and then grinded and sieved through a 325 mesh sieve.

(2) 200 g of the material obtained in step (1) was placed into a CVD reactor and the temperature was raised to 400° C. at a rate of 5° C./min, kept the temperature of 400° C. for 60 minutes to ensure temperature stability of the CVD reactor, and 0.6 L/min of SiH₄ and 0.6 L/min of nitrogen gas were introduced into the CVD reactor, a pressure of the reaction system was 0-30 Kpa, and the reaction system reacted for 300 minutes to obtain the first precursor.

(3) the first precursor was placed in a CVD reactor, the temperature was raised to 700° C. at a rate of 10° C./min, 1 L/min of C₃H₆ and 2 L/min of nitrogen gas were introduced into the CVD reactor, and reacted for 150 minutes.

(4) the material obtained in step (3) was placed in a VC mixer, grinded and sieved through a 325 mesh sieve to obtain the anode material.

The anode material obtained in this comparative example includes a core and a coating layer covering a surface of the core. The core includes porous carbon and silicon matrix inside and/or on the surface of the porous carbon. The silicon matrix exists in the form of SiH bonds, SiH₂ bonds, and SiH₃ bonds, and the coating layer is a carbon layer.

### Comparative Example 2

(1) 400 g of coal tar pitch, 120 g of calcium hydroxide, and 50 g of potassium hydroxide were mixed using a VC mixer with a stirring frequency of 20 Hz for 30 minutes to prepare a precursor having a uniform pore size distribution. After mixing evenly, the precursor was placed in a rotary furnace with an oxygen content of less than 100 ppm and a pressure of 10-100 pa. The mixture was heated to 700° C. at a rate of 10° C./min and kept at a constant temperature of 700° C. for 5 hours. The resulting material was soaked in 2 mol/L hydrochloric acid for 1 hour, filtered and washed with pure water until neutral, put in a 100° C. oven for 4 hours, and then grinded and sieved through a 325 mesh sieve.

(2) 200 g of the material obtained in step (1) was placed into a CVD reactor and the temperature was raised to 900° C. at a rate of 5° C./min, kept the temperature of 900° C. for 60 minutes to ensure temperature stability of the CVD reactor, and 0.6 L/min of SiH₄ and 0.6 L/min of nitrogen gas were introduced into the CVD reactor, a pressure of the reaction system was 0-30 Kpa, and the reaction system reacted for 300 minutes to obtain the first precursor.

(3) the first precursor was placed in a CVD reactor, the temperature was raised to 700° C. at a rate of 10° C./min, 1 L/min of C₃H₆ and 2 L/min of nitrogen gas were introduced into the CVD reactor and reacted for 150 minutes.

(4) the material obtained in step (3) was placed in a VC mixer, grinded and sieved through a 325 mesh sieve to obtain the anode material.

The anode material obtained in this comparative example includes a core and a coating layer covering a surface of the core. The core includes porous carbon and polycrystalline silicon inside and/or on the surface of the porous carbon. The coating layer is a carbon layer.

### Performance Testing:

1. Testing method for porosity, pore size, and proportion can be obtained by calculating a product of a number of pores per unit weight of the material (cm³/g) and a bulk density (g/cm³). Therefore, the porosity can be expressed based on volume as (volume/volume). The bulk density can be obtained by dividing a mass of the material by a volume of the sample. A number of pores per unit weight can be further measured under known conditions using nitrogen adsorption methods (micropores and mesopores) or mercury porosimeters (macropores).

2. A laser particle size analyzer is used to measure the D50, D00, and D90 of the anode material, which exhibit a symmetrical distribution similar to a normal distribution. D90 is a particle size with a cumulative volume distribution of 90% of the material particles. D00 is a minimum size of material particles, which refers to the smallest diameter that can be measured in the above distribution. D50 is a particle size of the material with a cumulative volume distribution of 50%, also known as the median particle size.

3. A specific weight method is used to determine a mass proportion of the silicon matrix (i.e. silicon element) in the anode material. Specifically, the silicon matrix can be burned at high temperature in air to generate silicon dioxide. By calculating the mass of silicon dioxide, the mass of silicon matrix can be derived, and then the mass proportion of silicon matrix in the anode materials can be calculated.

4. Renishaw confocal Raman spectrometer from the UK is used as the testing instrument, model inVia, testing conditions: using a 633 nm laser, with a testing range of 800 cm⁻¹ to 2000 cm⁻¹.

5. Thermo Scientific iN10 instrument from the United States is used for Fourier infrared spectroscopy testing, with a spectral range from 4000 cm⁻¹ to 400 cm⁻¹. The infrared test data was imported into Origin software, and the stretching vibration peak of SiH bond at wavenumber of 1985 cm⁻¹ and the stretching vibration peak of SiH₂ bond at wavenumber of 2080 cm⁻¹ as the double peak fitting positions. The infrared spectrum at wavenumber 1750-2220 cm⁻¹ is optimized using Gauss fitting method, and a value of Z of peak area represents the ratio of SiH bond to SiH₂ bond.

6. Lithium-ion batteries were prepared using the anode materials obtained from Comparative Examples 1-2 and Embodiments 1-13 as active materials. The preparation process is as follows.

Binder preparation: polyacrylic acid and sodium carboxymethyl cellulose were mixed in a 1:1 mass ratio, a certain amount of pure water was added, and was stirred magnetically for 6-12 hours. Silicon composite material and conductive agent were added to a binder, and a mass ratio of the silicon composite material, conductive agent, to the binder is 70:15:15, and was stirred magnetically for 6-12 hours to obtain a slurry. Preparation of electrode sheets: the slurry was applied evenly onto a copper foil, air dried, sliced and dried to obtain silicon composite electrode sheets.

Button type batteries were assembled to test their electrochemical performance, wherein the battery case used is CR2032, with metal lithium sheet as the counter electrode and LiPF₆ of 1 M as the electrolyte. The embodiments 1 to 13 are denoted as S1 to S13, and Comparative Examples 1 to 2 are denoted as D1 to D2.

TABLE 1
Parameters of the Anode materials in Embodiments and Comparative
Examples

| | Average | | | | | | | | | |
|---|---|---|---|---|---|---|---|---|---|---|
| | particle size | Silicon | Anode | Anode | Anode | Porosity of | | vibrational | vibrational | |
| | of silicon | content | material | material | material | anode | | peak area of | peak area of | Z |
| Sample | matrix (nm) | (%) | D00 (μm) | D50 (μm) | D90 (μm) | material (%) | I_{D}/I_{G} | SiH₂ bond | SiH bond | value |
| D1 | 9.2 | 38.9 | 1.5 | 8.5 | 22.3 | 10.0 | 2.5 | 427.5 | 63.7 | 6.71 |
| D2 | / | 50.11 | 1.8 | 9.9 | 25.1 | 3.1 | 2.2 | / | / | / |
| S1 | 2.9 | 49.1 | 1.9 | 7.7 | 18.9 | 3.4 | 2.5 | 36.7 | 458.8 | 0.08 |
| S2 | 3.0 | 47.5 | 1.8 | 7.5 | 18.4 | 4.8 | 2.1 | 32.4 | 462.9 | 0.07 |
| S3 | 3.3 | 46.2 | 1.6 | 7.3 | 18.1 | 6.8 | 1.7 | 30.2 | 377.5 | 0.08 |
| S4 | 9.1 | 43.7 | 1.3 | 5.9 | 14.0 | 8.5 | 2.2 | 772.1 | 177.1 | 4.36 |
| S5 | 8.5 | 46.5 | 1.2 | 6.7 | 14.9 | 6.7 | 2.1 | 613.9 | 220.9 | 2.78 |
| S6 | 7.7 | 46.8 | 1.5 | 6.8 | 15.3 | 6.0 | 2.1 | 512.4 | 507.3 | 1.01 |
| S7 | 5.4 | 47.4 | 1.7 | 8.1 | 19.0 | 4.4 | 2.1 | 134.1 | 319.4 | 0.42 |
| S8 | 8.7 | 48.6 | 1.3 | 8.9 | 23.1 | 4.0 | 2.1 | 30.5 | 762.5 | 0.04 |
| S9 | 10.0 | 50.3 | 2.0 | 10.0 | 25.0 | 3.1 | 2.1 | 28.9 | 722.5 | 0.04 |
| S10 | 10.1 | 50.5 | 2.0 | 10.1 | 25.1 | 3.2 | 2.1 | 10.1 | 505.0 | 0.02 |
| S11 | 9.2 | 47.5 | 1.8 | 8.6 | 23.7 | 5.0 | 2.2 | 486.6 | 99.9 | 4.87 |
| S12 | 9.8 | 47.6 | 1.9 | 9.5 | 24.5 | 5.3 | 2.1 | 32.6 | 815.0 | 0.04 |
| S13 | 3.2 | 48.0 | 2.0 | 7.8 | 22.2 | 4.7 | 2.3 | 31.8 | 397.5 | 0.08 |

TABLE 2
Electrochemical Properties of Anode materials Prepared
by Embodiments and Comparative Examples

| | | | | Capacity |
|---|---|---|---|---|
| | | Initial | Electrode | Retention |
| | Capacity | Efficiency | Expansion | Rate after 50 |
| Sample | (mAh/g) | (%) | Rate (%) | cycles (%) |
| D1 | 1400 | 81.5 | 39.8 | 76.2 |
| D2 | 1930 | 91.0 | 40.0% | 82.2 |
| S1 | 1905 | 90.7 | 38.4 | 83.6 |
| S2 | 1830 | 91.8 | 35.4 | 92.0 |
| S3 | 1750 | 91.1 | 37.9 | 88.4 |
| S4 | 1510 | 87.7 | 37.5 | 86.7 |
| S5 | 1648 | 89.3 | 37.3 | 91.3 |
| S6 | 1672 | 89.9 | 37.0 | 90.7 |
| S7 | 1694 | 90.5 | 36.6 | 88.9 |
| S8 | 1877 | 90.8 | 37.6 | 86.7 |
| S9 | 1933 | 91.1 | 38.0 | 85.2 |
| S10 | 1944 | 91.2 | 38.8 | 84.9 |
| S11 | 1799 | 91.3 | 38.1 | 85.5 |
| S12 | 1727 | 90.7 | 38.6 | 83.3 |
| S13 | 1850 | 91.7 | 36.0 | 89.5 |

By comparison of test results from Tables 1 to 2, it can be found that the anode material of this disclosure includes silicon matrix and porous carbon, at least a portion of the silicon matrix is distributed in the pores of the porous carbon, and a value of Z of the vibration peak area of SiH₂ bonds to the vibration peak area of SiH bonds in the anode material is 0.01-5.0. This indicates that during the preparation process of the anode material, pyrolysis of the silane is sufficient, resulting in more silicon matrix in the form of amorphous silicon with SiH bonds in the anode material, which can alleviate the volume expansion of the anode material, reduce the swelling of the electrode sheet prepared by the anode material, and improve the cycling and rate performance of the anode material.

Under a same condition, the greater the value of I_{D}/I_{G}, the easier it is for silane to deposit on carbon materials. However, excessive silicon deposition can reduce the cycling and rate performance of the anode material. In Embodiments 1-3, as the heat treatment temperature increases in the step (1), the value of I_{D}/I_{G} gradually decreases. In Embodiment 2 of this disclosure, the silicon matrix deposition amount of the anode material is appropriate, resulting in optimal both of the initial efficiency and expansion performance of the anode material.

The pyrolysis temperature of the silane in this disclosure has a significant impact on the performance of anode materials. In Embodiments 2, 4, 5, 6, 7, 8, 9, and 10, as the pyrolysis temperature of the silane increases, the value of Z decreases, indicating that the pyrolysis of the silane is becoming more and more sufficient, and the conversion rate of pyrolysis of the silane is improved. However, the high pyrolysis temperature of the silane can lead to a transformation of amorphous silicon to crystalline silicon. Therefore, when the pyrolysis temperature of the silane into silicon matrix is 550° C., the anode material can simultaneously achieve better cycling performance and expansion performance.

In Embodiments 4 and 11, at a certain temperature and under the same conditions of silane deposition, a pyrolysis degree of the silane did not change significantly with the extension of reaction time, indicating that whether pyrolysis of the silane was sufficiently affected mainly depends on the pyrolysis temperature of silane.

The anode material prepared by comparative example 1 has a lower pyrolysis temperature of silane, resulting in a lower conversion rate of silane pyrolysis and a less loading amount of the silicon on the porous substrate. SiH₂ bonds, SiH₃ bonds, and SiH bonds exist in the silicon matrix where the silane is not fully pyrolyzed, and the amount of SiH bonds is relatively little. This leads to Z not being within the range of 0.01-5.0, greatly reducing the structural stability of the anode material and resulting in poor cycling performance, capacity, and rate performance of the anode material.

For the anode material prepared in Comparative Embodiment 2, the pyrolysis temperature of the silane was too high, resulting in pyrolysis of the silane to produce polycrystalline silicon. The volume expansion of polycrystalline silicon was significant, leading to poor cycling and expansion performance of the anode material.

Although embodiments of the present invention have been shown and described, those skilled in the art may understand that various changes, modifications, substitutions, and variations can be made to these embodiments without departing from the principles and objectives of the present invention. The scope of the present invention is limited by the claims and their equivalents.

What is claimed is:

1. An anode material comprising:
an active material, the active material comprising a porous matrix and a silicon matrix, at least a portion of the silicon matrix is distributed in pores of the porous matrix,
wherein in an infrared spectrum obtained by testing the anode material using an infrared spectrometer, there are a stretching vibration peak of SiH₂ bond at a wave number of 2090 cm⁻¹ and a stretching vibration peak of SiH bond at a wave number of 2000 cm⁻¹;
a ratio Z of an area of the stretching vibration peak of the SiH₂ bond to an area of the stretching vibration peak of the SiH bond is in a range from 0.01 to 5.0.

2. The anode material of claim 1, wherein the ratio Z is in a range from 0.05 to 3.0, or the ratio Z is in a range from 0.05 to 0.5.

3. The anode material of claim 1, wherein a porosity of the anode material after removing the silicon matrix is in a range from 30% to 70%.

4. The anode material of claim 1, wherein an average pore size of the anode material after removing the silicon matrix is in a range from 0.2 nm to 10 nm.

5. The anode material of claim 1, wherein an average particle size of the silicon matrix is in a range from 1 nm to 10 nm.

6. The anode material of claim 1, wherein a weight percentage of the silicon matrix in the anode material is in a range from 5% to 90%.

7. The anode material of claim 1, wherein at least a portion of the silicon matrix is distributed on a surface of the porous matrix.

8. The anode material of claim 1, further comprising a coating layer on at least a portion of surfaces of the active material, wherein the anode material comprises at least one of feature (1) and feature (2):
(1) the coating layer comprises at least one of carbon material, metal oxide, and metal sulfide;
(2) a thickness of the coating layer is in a range from 5 nm to 500 nm.

9. The anode material of claim 8, wherein the anode material comprises at least one of feature (3), feature (4), and feature (5):
(3) the coating layer comprises the carbon material; the carbon material comprises at least one of graphene, soft carbon, hard carbon, and conductive polymers;
(4) the coating layer comprises the metal oxide, the metal oxide comprises at least one of titanium oxide, aluminum oxide, lithium oxide, cobalt oxide, and vanadium oxide;
(5) the coating layer comprises the metal sulfide, the metal sulfide comprises at least one of tin sulfide, molybdenum sulfide, titanium sulfide, iron sulfide, and copper sulfide.

10. The anode material of claim 1, wherein the anode material comprises at least one of feature (6), feature (7), and feature (8):
(6) a median particle size D50 of the anode material is in a range from 5 μm to 10 μm;
(7) a minimum particle size D00 of the anode material is in a range from 1 μm to 3 μm; and
(8) a D90 of the anode material is in a range from 14 μm to 25 μm.

11. The anode material of claim 1, wherein the anode material is shown in a Raman spectrum obtained by a Raman spectroscopy using a measurement light source having a wavelength of 633 nm, the anode material has a characteristic peak I_{D} at 1310 cm⁻¹ to 1350 cm⁻¹ and a characteristic peak I_{G} at 1580 cm⁻¹ to 1620 cm⁻¹, a ratio I_{D}/I_{G} of an area of the characteristic peak I_{D} to an area of the characteristic peak I_{G} is in a range from 1.6 to 2.5, or the ratio I_{D}/I_{G} is in a range from 1.8 to 2.2.

12. The anode material of claim 1, wherein the anode material comprises at least one of feature (9), feature (10), and feature (11):
(9) a specific surface area of the anode material ranges from 1.0 m²/g to 10.0 m²/g;
(10) a powder conductivity of the anode material is in a range from 0.1 S/cm to 10.0 S/cm; and
(11) a porosity of the anode material is in a range from 0.01% to 10%.

13. A lithium-ion battery comprising an anode and a cathode, the anode comprising an anode material,
the anode material comprising:
an active material, the active material comprising a porous matrix and a silicon matrix, at least a portion of the silicon matrix is distributed in pores of the porous matrix;
wherein in an infrared spectrum obtained by testing the anode material using an infrared spectrometer, there are a stretching vibration peak of SiH₂ bond at a wave number of 2090 cm⁻¹ and a stretching vibration peak of SiH bond at a wave number of 2000 cm⁻¹;
a ratio Z of an area of the stretching vibration peak of the SiH₂ bond to an area of the stretching vibration peak of the SiH bond is in a range from 0.01 to 5.0.

14. The lithium-ion battery of claim 13, wherein the ratio Z is in a range from 0.05 to 3.0; or the ratio Z is in a range from 0.05 to 0.5.

15. The lithium-ion battery of claim 13, wherein the anode material comprises at least one of feature (1), feature (2), feature (3), and feature (4):
(1) a porosity of the anode material after removing the silicon matrix is in a range from 30% to 70%;
(2) an average pore size of the anode material after removing the silicon matrix is in a range from 0.2 nm to 10 nm;
(3) an average particle size of the silicon matrix is in a range from 1 nm to 10 nm;
(4) a weight percentage of the silicon matrix in the anode material is in a range from 5% to 90%.

16. The lithium-ion battery of claim 13, wherein at least a portion of the silicon matrix is distributed on a surface of the porous matrix.

17. The lithium-ion battery of claim 13, wherein the anode material further comprises a coating layer on at least a portion of surfaces of the active material, the anode material comprises at least one of feature (5) and feature (6):
(5) the coating layer comprises at least one of carbon material, metal oxide, and metal sulfide;
(6) a thickness of the coating layer is in a range from 5 nm to 500 nm.

18. The lithium-ion battery of claim 13, wherein the anode material comprises at least one of features (7), feature (8), and feature (9):
(7) the coating layer comprises the carbon material; the carbon material comprises at least one of graphene, soft carbon, hard carbon, and conductive polymer;
(8) the coating layer comprises the metal oxide, the metal oxide comprises at least one of titanium oxide, aluminum oxide, lithium oxide, cobalt oxide, and vanadium oxide;
(9) the coating layer comprises the metal sulfide, the metal sulfide comprises at least one of tin sulfide, molybdenum sulfide, titanium sulfide, iron sulfide, and copper sulfide.

19. The lithium-ion battery of claim 13, wherein the anode material comprises at least one of features (10), feature (11), and feature (12):
(10) a median particle size D50 of the anode material is in a range from 5 μm to 10 μm;
(11) a minimum particle size D00 of the anode material is in a range from 1 μm to 3 μm;
(12) a D90 of the anode material is in a range from 14 μm to 25 μm.

20. The lithium-ion battery of claim 13, wherein the anode material is shown in a Raman spectrum obtained by a Raman spectroscopy using a measurement light source having a wavelength of 633 nm; the anode material has a characteristic peak I_{D} at 1310 cm⁻¹ to 1350 cm⁻¹ and a characteristic peak I_{G} at 1580 cm⁻¹ to 1620 cm⁻¹; a ratio I_{D}/I_{G} of an area of the characteristic peak I_{D} to an area of the characteristic peak I_{G} is in a range from 1.6 to 2.5, or the ratio I_{D}/I_{G} is in a range from 1.8 to 2.2.
